(19) United States
(12) Patent Application Publication
(10) Pub. No.: US 2025/0108389 A1
(43) Pub. Date: Apr. 3, 2025

(54) EASY-TO-INSTALL BATHTUB MASSAGE NOZZLE

(71) Applicant: Guangzhou Rising Dragon Recreation Industrial Co., Ltd., Guangzhou (CN)

(72) Inventors: Huaibin ZHAO, Guangzhou (CN); Xuewen LIU, Guangzhou (CN)

(73) Assignee: Guangzhou Rising Dragon Recreation Industrial Co., Ltd., Guangzhou (CN)

(21) Appl. No.: 18/679,500

(22) Filed: May 31, 2024

(30) Foreign Application Priority Data
Sep. 28, 2023 (CN) 202322650642.3

(51) Int. Cl. B05B 1/18; B05B 15/60

(52) U.S. Cl. CPC B05B 1/18; B05B 15/60

(57) ABSTRACT

An easy-to-install bathtub massage nozzle includes a nozzle body and a nozzle core seat. The nozzle core seat is inserted through an accommodating through hole of the nozzle body, and then the nozzle core seat is pressed, so that an annular rubber ring on the nozzle core seat is squeezed and compressed. When pressed to an annular groove on the nozzle body, the annular rubber ring returns to its original shape and expands into the annular groove, so that the nozzle core seat and the nozzle body can be tightly connected. The bathtub massage nozzle greatly simplifies the installation process, and users only need to insert and press easily to complete the installation without complicated rotation and tightening operations. In addition, the combination of the annular groove and the annular rubber ring also effectively improves the sealing performance, so that the water outlet effect is improved.

### TECHNICAL FIELD

The present invention relates to the technical field of bathtub nozzles, in particular to an easy-to-install bathtub massage nozzle.

### BACKGROUND

Traditional bathtub massage nozzles are usually designed to be installed by threaded connection, in which a nozzle body and a nozzle core seat are connected by rotating and tightening the threads. For example, in a massage nozzle described in China patent application number CN202121128762.1 granted on Nov. 26, 2021, the nozzle body and nozzle core seat are connected in a threaded way. However, there may be some problems in this threaded connection, mainly including installation complexity and poor installation sealing.

First of all, the threaded connection method requires users to perform multi-turn rotation and tightening operations, and the installation process is complicated. Secondly, the tightness of the threaded connection may be unstable. Because the threaded connection can be easily affected by component looseness or damage, it may lead to poor sealing at the installation area, which may result in a poor use effect of the massage nozzle. Therefore, a more convenient, reliable and easy-to-install design of the bathtub massage nozzle is needed to solve the problems that may be caused by traditional connection methods.

### SUMMARY

The present invention is directed to an easy-to-install bathtub massage nozzle, which can solve the problems of the inconvenience and poor sealing effect of the connection between the nozzle body and the nozzle core seat.

According to one embodiment, an easy-to-install bathtub massage nozzle includes a nozzle body and a nozzle core seat, wherein the nozzle body includes a water inlet end and an opposite water outlet end, and the water inlet end is provided with a water inlet and an air inlet. The water inlet and the air inlet are staggeredly arranged with each other, and the water outlet end is formed with an accommodating through hole for allowing insertion of the nozzle core seat. An annular groove is formed on an inner surface of the accommodating through hole by recessing toward an outer surface of the water outlet end. The nozzle core seat comprises a nozzle core seat body and a nozzle surface cover arranged at an end of the nozzle core seat body, an annular accommodating groove is arranged on the outer side of the nozzle core seat body, and an annular rubber ring adapted to the annular groove is arranged in the annular accommodating groove.

Preferably, a nozzle core is arranged on a side of the nozzle core seat body close to the nozzle surface cover, and a water outlet is arranged on the nozzle surface cover corresponding to the nozzle core.

Preferably, the nozzle core is a spherical nozzle core, a straight nozzle core, a rotatory nozzle core or a multi-port nozzle core. In use, different types of nozzle core seats can be chosen (that is, choose different nozzle cores) according to the user own preferences and needs, such as spherical, linear, rotary or multi-port nozzle cores, so as to obtain personalized and diversified massage effects.

Preferably, a support plane is arranged at a middle part of an inside of the nozzle body; the support plane is perpendicular to an axis in a longitudinal direction of the nozzle body, and a water through hole and a protrusion are arranged on the support plane; the water through hole runs through the middle of the support plane, and the provision of the water through hole enables the water entering from one side where the water inlet is located to be ejected out from another side where the nozzle surface cover 200 is located. The protrusion extends toward the nozzle surface cover. A surface of the nozzle core seat body opposite to the support plane is provided with a cam corresponding to the protrusion.

Preferably, an included angle between one side of the protrusion and the support plane is an acute angle. It should be noted that, as a preferred solution, the protrusion can be arranged in a structure similar to a right triangle, in which one right-angle side is connected with the support plane. The cam is a sheet-like structure which is similar to a rectangular body and protrudes from the nozzle core seat body to the side away from the nozzle surface cover, and the corner is treated with arc transition. It is to be understood that the protrusion is not necessarily a structure similar to a right triangle, as long as it has an inclined plane inclined from the side of the support plane to the side of the nozzle surface cover.

When the nozzle body and the nozzle core seat need to be disassembled, the user only needs to rotate the nozzle core seat. When the cam reaches the lowest end of the protrusion where the protrusion connects with the support plane, the protrusion and the cam begin to contact each other. The nozzle core seat is continually rotated, and the cam will gradually move upward (that is, to the nozzle surface cover side) along the inclined plane of the protrusion. Due to the force provided in the direction away from the water inlet end, the annular groove on the nozzle body can be easily separated from the annular rubber ring on the nozzle core seat. The nozzle core seat is continually rotated, and the nozzle core seat can be easily removed from the nozzle body. Through this design, it is simple and convenient to disassemble the nozzle body from nozzle core seat. The user only needs to rotate the nozzle core seat to make the protrusion engage the cam, providing a force sufficient to make the annular groove on the nozzle body separate from the annular rubber ring on the nozzle core seat. In this way, users can easily replace, clean or repair the nozzle core seat to achieve better maintenance and use experience.

Preferably, the nozzle core seat body is provided with a catch slot, and a side of the nozzle surface cover is provided with a catch engaged in the catch slot. During installation, the connection between the nozzle surface cover and the nozzle core seat body is realized by the catch on the nozzle surface cover engaged into the catch slot at the nozzle core seat body, which is simple and reliable.

Preferably, the easy-to-install bathtub massage nozzle further includes a fastener provided with an internal thread, and the outer side of the nozzle body is provided with an external thread. The fastener is screwed onto the external thread of the nozzle body, and is engaged with the nozzle surface cover to realize the installation of the bathtub massage nozzle at the installation position on the bathtub.

Compared with the prior art, the present invention has the following beneficial effects: the present invention provides an easy-to-install bathtub massage nozzle, which includes a nozzle body and a nozzle core seat. During installation, the nozzle core seat is inserted through the accommodating through hole contained in the nozzle body, and then the nozzle core seat is pressed, so that the annular rubber ring arranged on the nozzle core seat is squeezed and compressed; when the annular rubber ring is pressed to the annular groove arranged on the nozzle body, the annular rubber ring is restored to its original shape and expands into the annular groove, so that the nozzle core seat and the nozzle body can be closely connected. Therefore, the easy-to-install bathtub massage nozzle greatly simplifies the installation process, and users only need to insert and press easily to complete the installation without complicated rotation and tightening operations; at the same time, the combination of the annular groove on the nozzle body and the annular rubber ring on the nozzle core seat also effectively improves the sealing performance of the installation, so that the water outlet effect is better.

### BRIEF DESCRIPTION OF DRAWINGS

FIG. 1 is a schematic structural diagram of an easy-to-install bathtub massage nozzle according to one embodiment of the present invention;

FIG. 2 is a schematic view of the sectional structure of the easy-to-install bathtub massage nozzle according to one embodiment of the present invention;

FIG. 3 is a schematic structural diagram of the nozzle body of the easy-to-install bathtub massage nozzle according to one embodiment of the present invention;

FIG. 4 is a schematic structural diagram of the nozzle body of the easy-to-install bathtub massage nozzle according to one embodiment of the present invention;

FIG. 5 is a schematic structural diagram of the nozzle core seat of the easy-to-install bathtub massage nozzle according to one embodiment of the present invention;

FIG. 6 is a schematic cross-sectional view of an easy-to-install bathtub massage nozzle with a spherical nozzle core;

FIG. 7 is a schematic cross-sectional view of an easy-to-install bathtub massage nozzle with a multi-port nozzle core;

FIG. 8 is a schematic cross-sectional view of an easy-to-install bathtub massage nozzle with a straight nozzle core; and

FIG. 9 is a schematic cross-sectional view of an easy-to-install bathtub massage nozzle with a rotary nozzle core.

In the Figures:

100—Nozzle body, 200—Nozzle core seat, 110—Water inlet, 120—Air inlet, 130—Accommodating through hole, 140—Annular groove, 160—Support plane, 170—Protrusion, 180—External thread, 190—Fastener, 210—Nozzle core seat body, 220—Nozzle surface cover, 230—Annular accommodating groove, 240—Annular rubber ring, 250—Cam, 260—Catch slot, 270—Catch, 280—Nozzle core.

### DESCRIPTION OF EMBODIMENTS

In order to make objectives, technical solutions and advantages of the embodiments of the present invention clearer, the technical solutions of the embodiments of the present invention will be described clearly and completely below with reference to the accompanying drawings in the embodiments of the present invention.

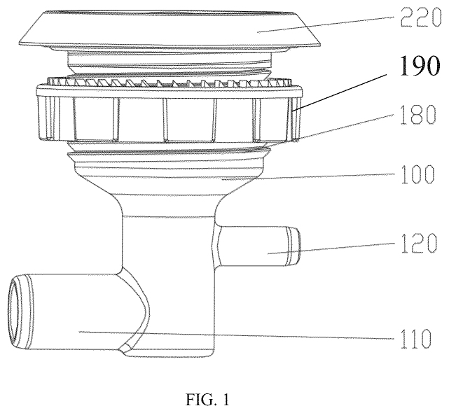

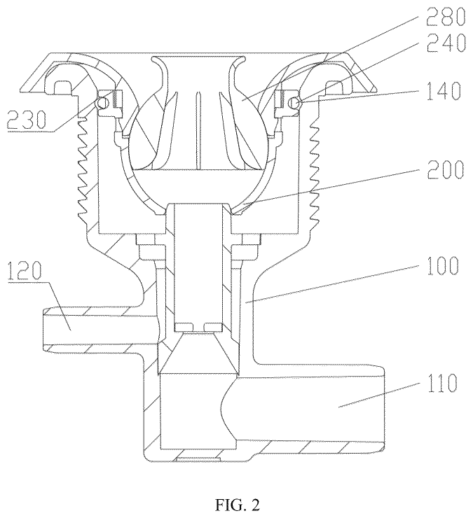

Referring to FIGS. 1 to 9, this embodiment provides an easy-to-install bathtub massage nozzle, and it includes a nozzle body 100 and a nozzle core seat 200. The nozzle body 100 includes a water inlet end and an opposite water outlet end. The water inlet end is provided with a water inlet 110 and an air inlet 120, which are staggeredly positioned with each other, and the water outlet end is formed with an accommodating through hole 130 for allowing insertion of the nozzle core seat 200. An annular groove 140 is formed on an inner surface of the accommodating through hole 130 by recessing toward an outer surface of the water outlet end. The nozzle core seat 200 includes a nozzle core seat body 210 and a nozzle surface cover 220 arranged at an end of the nozzle core seat body 210. An annular accommodating groove 230 is arranged on an outer side of the nozzle core seat body 210, and an annular rubber ring 240 adapted to the annular groove 140 is arranged in the annular accommodating groove 230.

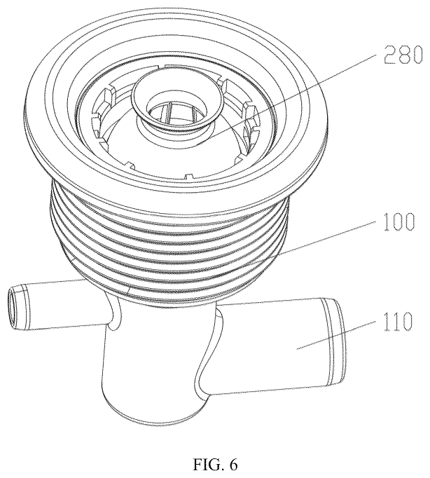

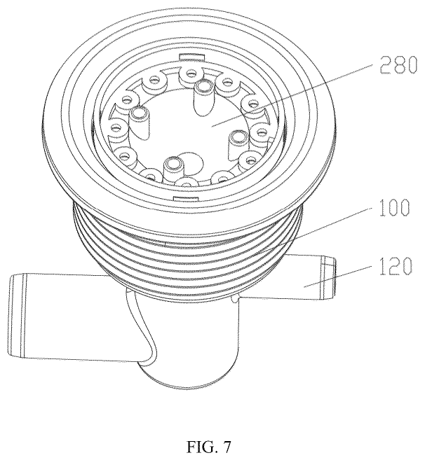

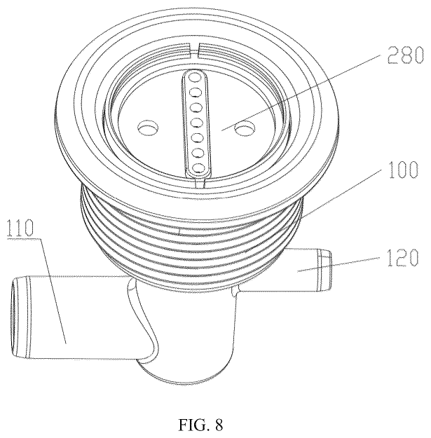

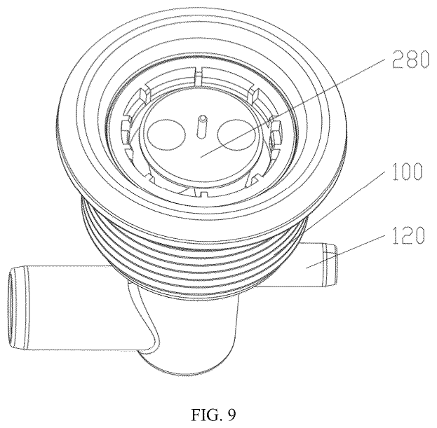

Referring to FIG. 6, FIG. 7, FIG. 8 and FIG. 9, preferably, a nozzle core 280 is arranged on one side of the nozzle core seat body 210 near the nozzle surface cover 220, and a water outlet corresponding to the nozzle core 280 is arranged on the nozzle surface cover 220. Further, the nozzle core 280 can be a spherical nozzle core 280, a straight nozzle core 280, a rotary nozzle core 280 or a multi-port nozzle core. In use, different types of nozzle core seats 200 (that is, different nozzle cores 280) can be chosen according to the user own preferences and needs, such as spherical, straight, rotatory or multi-port nozzle cores 280, so as to obtain personalized and diversified massage effects.

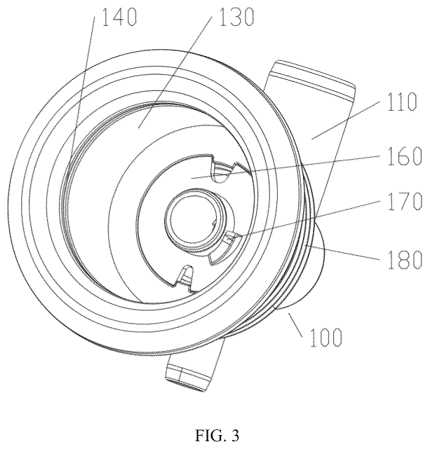

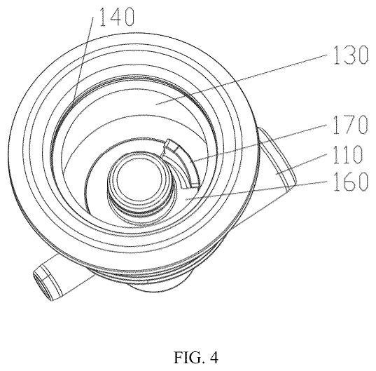

Referring to FIG. 3 and FIG. 4, a support plane 160 is disposed at a middle of an inside of the nozzle body 100, which is perpendicular to the axis in the longitudinal direction of the nozzle body 100. The support plane 160 is provided with a water through hole and a protrusion 170. The water through hole runs through the middle part of the support plane 160, and the provision of the water through hole enables the water entering from one side where the water inlet is located to be ejected out from another side where the nozzle surface cover 200 is located. The protrusion 170 extends toward the nozzle surface cover 220. Referring to FIG. 4, further, a surface of the nozzle core seat body 210 opposite to the support plane 160 is provided with a cam 250 corresponding to the protrusion 170. An acute angle is formed between one side of the protrusion 170 and the support plane 160. It should be noted that, as a preferred solution, the protrusion 170 can be arranged as a structure similar to a right triangle, with one right-angle side connected with the support plane 160. The cam 250 is a sheet-like structure similar to a rectangular body that protrudes toward the side away from the nozzle surface cover 220, and the corner of the cam 250 is processed by arc transition. Of course, the protrusion 170 is not required to be a nearly right triangle structure, it is only required to have an inclined plane inclined from the support plane side to the nozzle surface cover side, which will not be described in detail here. According to FIG. 3 and FIG. 4, it can be known that the protrusion 170 in this embodiment can be set in different positions according to needs. For example, the protrusion 170 can also be set on the nozzle body 100, without limiting its specific position setting, as long as the protrusion 170 and the cam 250 can cooperate to facilitate the disassembly of the nozzle core seat 200.

When it is desired to disassemble the nozzle body 100 from the nozzle core seat 200, the user only needs to rotate the nozzle core seat 200. When the cam 250 reaches the lowest end of the protrusion 170 where the protrusion 170 connects with the support plane 160, the protrusion 170 comes into contact with the cam 250. The nozzle core seat 200 is continually rotated, and the cam 250 gradually moves upward (i.e. toward the nozzle surface cover 220) along the inclined plane of the protrusion 170. The annular groove 140 on the nozzle body 100 can be easily separated from the annular rubber ring 240 on the nozzle core seat 200 due to the force provided in the direction away from the water inlet end. The nozzle core seat 200 is continually rotated, and the nozzle core seat 200 can be easily removed from the nozzle body 100. With this design, it is simple and convenient to disassemble the nozzle body 100 and the nozzle core seat 200. The user only needs to rotate the nozzle core seat 200 to make the protrusion 170 engage with the cam 250, providing a force sufficient to make the annular groove 140 on the nozzle body 100 separate from the annular rubber ring 240 on the nozzle core seat 200. In this way, the user can easily replace, clean or repair the nozzle core seat 200, so as to achieve a better maintenance and use experience.

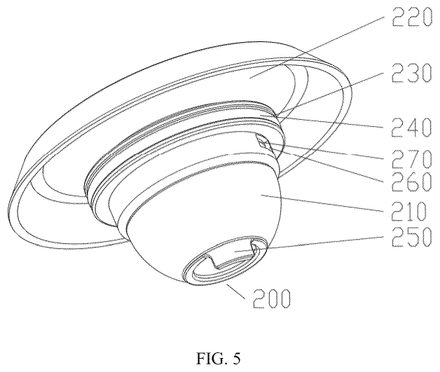

Referring to FIG. 5, it is preferred that the nozzle core seat body 210 is provided with a catch slot 260, and the side of the nozzle surface cover 220 is provided with a catch 270 matched with the catch slot 260. During installation, the connection between the nozzle surface cover 220 and the nozzle core seat body 210 is realized by engaging the catch 270 on the nozzle surface cover 220 into the catch slot 260 at the nozzle core seat body 210, which is simple and reliable.

Referring to FIG. 1, the easy-to-install bathtub massage nozzle further includes a fastener 190 provided with an internal thread, and an external thread 180 is provided on the outside of the nozzle body 100. The fastener 190 is screwed onto the external thread 180 of the nozzle body 100, and cooperates with the nozzle surface cover 220 to install the easy-to-install bathtub massage nozzle at the installation position on the bathtub.

The present invention provides an easy-to-install bathtub massage nozzle, which includes a nozzle body 100 and a nozzle core seat 200. In installing the easy-to-install bathtub massage nozzle, the nozzle core seat 200 is inserted through the receiving through hole 130 included in the nozzle body 100, and then the nozzle core seat 200 is pressed, so that the annular rubber ring 240 arranged on the nozzle core seat 200 is squeezed and compressed. When the annular rubber ring 240 is pressed to the annular groove 140 arranged on the nozzle body 100, the annular rubber ring 240 returns to its original shape and expands into the annular groove 140, so that the nozzle core seat 200 is tightly connected with the nozzle body 100. Therefore, the easy-to-install bathtub massage nozzle greatly simplifies the installation process, and users only need to insert and press easily to complete the installation without complicated rotation and tightening operations; at the same time, the combination of the annular groove 140 on the nozzle body 100 and the annular rubber ring 240 on the nozzle core seat 200 also effectively improves the sealing performance of the installation, so that the water outlet effect is better.

The above are only the preferred embodiments of this disclosure and do not therefore limit the patent scope of this disclosure. And equivalent structure or equivalent process transformation made by the specification and the drawings of this disclosure, either directly or indirectly applied in other related technical fields, shall be similarly included in the patent protection scope of this disclosure.

What is claimed is:

1. An easy-to-install bathtub massage nozzle, comprising a nozzle body and a nozzle core seat, wherein the nozzle body comprises a water inlet end and an opposite water outlet end, and the water inlet end is provided with a water inlet and an air inlet; the water inlet and the air inlet are staggeredly arranged with each other, and the water outlet end is formed with an accommodating through hole for allowing insertion of the nozzle core seat; an annular groove is formed on an inner surface of the accommodating through hole by recessing toward an outer surface of the water outlet end; the nozzle core seat comprises a nozzle core seat body and a nozzle surface cover arranged at an end of the nozzle core seat body, an annular accommodating groove is arranged on the outer side of the nozzle core seat body, and an annular rubber ring adapted to the annular groove is arranged in the annular accommodating groove.

2. The easy-to-install bathtub massage nozzle according to claim 1, wherein a nozzle core is arranged on a side of the nozzle core seat body close to the nozzle surface cover, and a water outlet is arranged on the nozzle surface cover corresponding to the nozzle core.

3. The easy-to-install bathtub massage nozzle according to claim 2, wherein the nozzle core is a spherical nozzle core, a straight nozzle core, a rotatory nozzle core or a multi-port nozzle core.

4. The easy-to-install bathtub massage nozzle according to claim 1, wherein a support plane is arranged at a middle part of an inside of the nozzle body; the support plane is perpendicular to an axis in a longitudinal direction of the nozzle body, and a water through hole and a protrusion are arranged on the support plane; the water through hole runs through the middle of the support plane, and the protrusion extends toward the nozzle surface cover; and a surface of the nozzle core seat body opposite to the support plane is provided with a cam corresponding to the protrusion.

5. The easy-to-install bathtub massage nozzle according to claim 2, wherein a support plane is arranged at a middle part of an inside of the nozzle body; the support plane is perpendicular to an axis in a longitudinal direction of the nozzle body, and a water through hole and a protrusion are arranged on the support plane; the water through hole runs through the middle of the support plane, and the protrusion extends toward the nozzle surface cover; and a surface of the nozzle core seat body opposite to the support plane is provided with a cam corresponding to the protrusion.

6. The easy-to-install bathtub massage nozzle according to claim 3, wherein a support plane is arranged at a middle part of an inside of the nozzle body; the support plane is perpendicular to an axis in a longitudinal direction of the nozzle body, and a water through hole and a protrusion are arranged on the support plane; the water through hole runs through the middle of the support plane, and the protrusion extends toward the nozzle surface cover; and a surface of the nozzle core seat body opposite to the support plane is provided with a cam corresponding to the protrusion.

7. The easy-to-install bathtub massage nozzle according to claim 4, wherein an included angle between one side of the protrusion and the support plane is an acute angle.

8. The easy-to-install bathtub massage nozzle according to claim 5, wherein an included angle between one side of the protrusion and the support plane is an acute angle.

9. The easy-to-install bathtub massage nozzle according to claim 6, wherein an included angle between one side of the protrusion and the support plane is an acute angle.

10. The easy-to-install bathtub massage nozzle according to claim 1, wherein the nozzle core seat body is provided with a catch slot, and a side edge of the nozzle surface cover is provided with a catch engaged in the catch slot.

11. The easy-to-install bathtub massage nozzle according to claim 1, further comprising a fastener provided with an internal thread, and an external thread is provided on an outside of the nozzle body; and the fastener cooperates with the nozzle surface cover to clamp the nozzle body for installation and fixation.
